(19) United States
(12) Patent Application Publication
(10) Pub. No.: US 2026/0300417 A1
(43) Pub. Date: Oct. 1, 2026

(54) INFORMATION PROCESSING METHOD, DEVICE AND NON-TRANSITORY COMPUTER-READABLE STORAGE MEDIUM

(71) Applicant: Beijing Zitiao Network Technology Co., Ltd., Beijing (CN)

(72) Inventors: Yan LU, Beijing (CN); Liqihan ZHOU, Beijing (CN); Haijin DENG, Beijing (CN); Weiqi LIU, Beijing (CN); Jiacheng DUAN, Beijing (CN); Fan JIANG, Beijing (CN); Wei LIU, Beijing (CN); Jingyi WEI, Beijing (CN); Shuhan LU, Beijing (CN); Xiaowen WANG, Beijing (CN)

(21) Appl. No.: 19/538,893

(22) Filed: Feb. 12, 2026

(30) Foreign Application Priority Data
Mar. 31, 2025 (CN) 202510398592.5

(51) Int. Cl. G06F 16/9535; G06F 3/0484

(52) U.S. Cl. CPC G06F 16/9535; G06F 3/0484

(57) ABSTRACT

Embodiments of the present disclosure provide an information processing method and device and a non-transitory computer-readable storage medium. The method includes: displaying a message indicating a conference report in a message feed; and displaying report content of the conference report in response to a trigger operation to the message, where the report content includes at least one summary content corresponding to at least one dimension, respectively, and the summary content of each dimension is obtained by performing content summarization on conference content of at least two multimedia conferences in each dimension correspondingly. Therefore, a user may be helped to automatically refine and review key information based on recent conference content, so as to quickly review and look ahead to a process of related items.

### CROSS-REFERENCE TO RELATED APPLICATION

This application claims the priority to and benefits of the Chinese Patent Application, No. 202510398592.5, which was filed on Mar. 31, 2025. The aforementioned patent application is hereby incorporated by reference in its entirety.

### TECHNICAL FIELD

Embodiments of the present disclosure relate to an information processing method and device, a non-transitory computer-readable storage medium, and a program product.

### BACKGROUND

Online information communication may be carried out between a plurality of users through a multimedia conference. At present, after the multimedia conference ends, a user needs to sort out conference content of the multimedia conference and sort out important information and to-do items.

With an increase in the number of conferences, the user needs to go through conference content one by one and sort out important information and to-do items of each conference, which easily leads to important information being missed and the to-do items being difficult to follow up in a timely manner.

### SUMMARY

Embodiments of the present disclosure provide an information processing method and device, a non-transitory computer-readable storage medium, and a program product.

In a first aspect, an embodiment of the present disclosure provides an information processing method, including:
displaying a message indicating a conference report in a message feed; and
displaying report content of the conference report in response to a trigger operation to the message, where the report content includes at least one summary content corresponding to at least one dimension, respectively, and the summary content of each dimension is obtained by performing content summarization on conference content of at least two multimedia conferences in each dimension correspondingly.

In a second aspect, an embodiment of the present disclosure provides an information processing device, including:
a first display unit, configured to display a message indicating a conference report in a message feed; and
a second display unit, configured to display report content of the conference report in response to a trigger operation to the message, where the report content includes at least one summary content corresponding to at least one dimension, respectively, and the summary content of each dimension is obtained by performing content summarization on conference content of at least two multimedia conferences in each dimension correspondingly.

In a third aspect, an embodiment of the present disclosure provides an electronic device, including: a processor and a memory;
the memory stores a computer-executable instruction; and
the processor executes the computer-executable instruction stored in the memory, and the computer-executable instruction, upon execution by the processor, causes the at least one processor to implement the information processing method according to the above first aspect and various possible designs of the first aspect.

In a fourth aspect, an embodiment of the present disclosure provides a non-transitory computer-readable storage medium, where a computer-executable instruction is stored in the non-transitory computer-readable storage medium, and the computer-executable instruction, when executed by a processor, implements the information processing method according to the above first aspect and various possible designs of the first aspect.

In a fifth aspect, an embodiment of the present disclosure provides a computer program product, including a computer program, where the information processing method according to the above first aspect and various possible designs of the first aspect is implemented when the computer program is executed by a processor.

According to the information processing method and device, the readable storage medium, and the program product provided in the embodiments, in the method, a message indicating a conference report is displayed in a message feed; report content of the conference report is displayed in response to a trigger operation to the message, where the report content includes at least one summary content corresponding to at least one dimension, respectively, and the summary content of each dimension is obtained by performing content summarization on conference content of at least two multimedia conferences in each dimension correspondingly. Therefore, a user may be helped to automatically refine and review key information based on recent intelligent meeting minutes, so as to quickly review and look ahead to a process of related items. Time costs of the user for going through and sorting out meeting minutes may be reduced, so as to more systematically manage and promote progress of the related items.

### BRIEF DESCRIPTION OF DRAWINGS

In order to more clearly describe the technical solutions in the embodiments of the present disclosure or in the prior art, the following briefly introduces the drawings required for describing the embodiments. Apparently, the drawings in the following description show some embodiments of the present disclosure, and other drawings may also be obtained by a person of ordinary skill in the art according to these drawings without creative efforts.

FIG. 1 is a first schematic flowchart of an information processing method according to an embodiment of the present disclosure;

FIG. 2 is a schematic diagram of an application scenario according to an embodiment of the present disclosure;

FIG. 3 is a second schematic flowchart of an information processing method according to an embodiment of the present disclosure;

FIG. 4 is a schematic diagram of an application scenario according to another embodiment of the present disclosure;

FIG. 5 is a block diagram of an information processing device according to an embodiment of the present disclosure; and

FIG. 6 is a schematic diagram of a hardware structure of an electronic device according to an embodiment of the present disclosure.

### DETAILED DESCRIPTION

In order to make the objectives, technical solutions, and advantages of the embodiments of the present disclosure clearer, the technical solutions in the embodiments of the present disclosure are described clearly and completely below with reference to the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

A plurality of users may communicate various information contents in a multimedia conference, such as a progress of a task that needs collaboration and to-do items of different collaborators.

At present, a user may record core information and action items related to the user during a conference, and after the conference, the user may manually sort out the core information and the action items related to the user in each of a plurality of multimedia conferences. In addition, meeting minutes of each multimedia conference may be reviewed to sort out core information of the plurality of conferences and action items of the user.

It may be seen that when sorting out content of the plurality of multimedia conferences, the user needs to perform a large number of manual operations, which wastes a lot of time and may cause omission of information and action items.

According to the solution provided in the present disclosure, content of multimedia conferences related to a user within a preset time period is aggregated, and information extraction is performed on the content of the multimedia conferences within the preset time period in different dimensions, which facilitates the user to quickly review core information of the plurality of multimedia conferences and promotes personal tasks based on aggregated to-do items. Time that the user spends on reviewing and sorting out information of the plurality of multimedia conferences may be reduced, and omission of information and the to-do items may also be avoided.

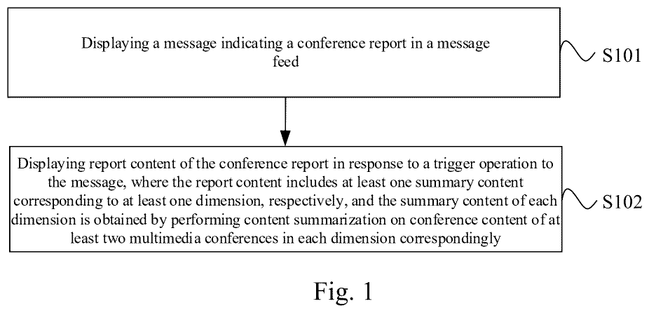

Please refer to FIG. 1. FIG. 1 is a first schematic flowchart of an information processing method according to the present disclosure. As shown in FIG. 1, the method includes the following steps.
S101: displaying a message indicating a conference report in a message feed.

In this embodiment, an execution body of the information processing method may be a terminal device, or specifically may be an application client that supports multimedia conferences and runs on the terminal device. In addition, the execution body of the information processing method may also be a server.

The message feed here may be a message feed sent to a user who logs in to the above application. The message feed may include one or more messages sent by other contacts to the user, and may also include one or more messages sent by an intelligent assistant to the user.

The intelligent assistant, for example, may be an intelligent assistant that may analyze and process content of multimedia conferences that the user has permission to view, and generate a conference report based on an analysis and processing result.

The at least two multimedia conferences may be multimedia conferences of which the user has permission to view conference content.

The intelligent assistant may generate a message based on the generated conference report, and send the message to the application client used by the user. The application client may display the message indicating the conference report in a message feed display interface of the user.

In some application scenarios, the intelligent assistant may directionally send the message to the user. For example, the message is sent to the user by “@” the user in the message feed.

Content in the conference report may be obtained by summarizing content of at least two multimedia conferences. Illustratively, the execution body may obtain conference content records of the at least two multimedia conferences, then analyze the conference content records, and generate the conference report based on an analysis result.

In some implementations, the conference report may be generated based on meeting minutes of at least two multimedia conferences that meet a preset condition.

The preset condition includes: the at least two multimedia conferences are within a preset time period, and the user to whom the message feed belongs is authorized to view meeting minutes of the at least two multimedia conferences.

Illustratively, the preset time period may include past N day(s), where N is an integer greater than or equal to 1, for example, N is equal to 7. When N is equal to 7, the conference report may be generated based on meeting minutes of multimedia conferences within the past 7 days. When a number of multimedia conferences of which the user has permission to view meeting minutes in the preset time period is greater than or equal to two, the execution body may generate the conference report based on the meeting minutes of the two or more multimedia conferences.

In some examples, each participant user in the multimedia conference has permission to browse the meeting minutes of the multimedia conference. In an example, an initiator of the multimedia conference or a user invited to participate in the conference has permission to browse the meeting minutes of the multimedia conference.

In some examples, the meeting minutes may be generated by a multimedia conference server based on detailed content of the multimedia conference.

In these implementations, the execution body may obtain the meeting minutes of the at least two multimedia conferences that meet the preset condition, and then generate the conference report based on the meeting minutes of the at least two multimedia conferences. A conference report with strong timeliness is generated based on a time period constraint, and a scope of multimedia conferences involved in the conference report is limited by user viewing permission, so that information leakage may be prevented.
S102: displaying report content of the conference report in response to a trigger operation to the message, where the report content includes at least one summary content corresponding to at least one dimension, respectively, and the summary content of each dimension is obtained by performing content summarization on conference content of at least two multimedia conferences in each dimension correspondingly.

The user may perform a trigger operation (such as a click operation or a touch operation) on the message in the message feed. After receiving the trigger operation, the execution body may display the report content of the conference report. In an example, a report content display window may be displayed on one side of a message feed display window. The report content is displayed in the report content display window. In an example, after the user performs the trigger operation to the message in the message feed, a report content display interface may be displayed, and the report content display interface may cover the message feed display interface.

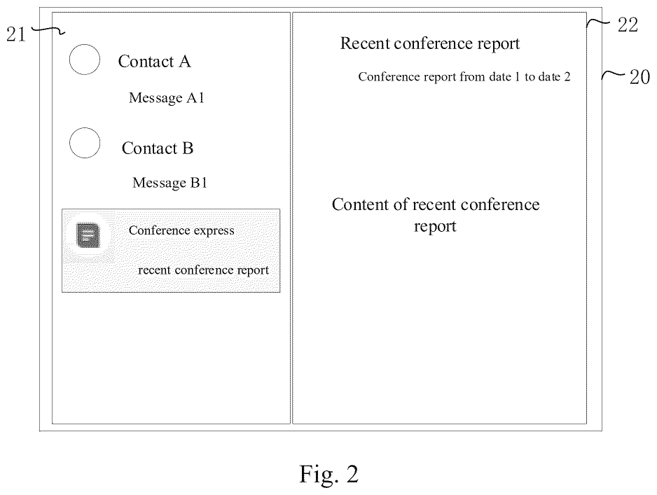

Please refer to FIG. 2. FIG. 2 is a schematic diagram of an application scenario according to an embodiment of the present disclosure. As shown in FIG. 2, a message feed display window 21 is displayed on a display screen 20, and the message feed display window 21 may include a plurality of messages. As shown in FIG. 2, a message A1 sent by a contact A, a message B1 sent by a contact B, and a recent conference report sent by an intelligent assistant conference express. The user may perform a trigger operation on the recent conference report in the message feed display window, so as to display a conference report display window 22, and the conference report display window 22 may display report content of the recent conference report.

In some application scenarios, the conference report display window further displays a navigation region; the navigation region displays a hierarchical structure of the report content; the hierarchical structure includes an identification corresponding to at least one dimension; and in response to a trigger operation performed on an identification of a target dimension, content corresponding to the target dimension is located in a detailed display region of the conference report display window.

In some implementations, the report content includes the at least one summary content corresponding to the at least one dimension of followings:
a dimension of a discussion theme with a discussion frequency exceeding a preset frequency dimension, a daily conference overview dimension, a to-do item dimension, and a meeting minutes summary dimension.

The discussion theme with the discussion frequency exceeding the preset frequency here refers to a discussion theme that appears more than a preset number of times in the plurality of multimedia conferences or is discussed at a frequency greater than a preset frequency in the plurality of multimedia conferences. Illustratively, the preset number of times here may be, for example, 2. The preset frequency may be, for example, 40%.

It may be understood that if the same discussion theme is discussed multiple times in the same multimedia conference, it may be considered that the discussion theme appears once.

Summary content of the discussion theme may be generated based on conference content of a plurality of multimedia conferences involving the discussion theme with the discussion frequency exceeding the preset frequency.

The multimedia conference content related to the user may be summarized on a daily basis to obtain the daily conference overview.

To-do items that need to be executed by the user in the plurality of pieces of multimedia conference content related to the user may be extracted to generate summary content of the to-do items.

In these implementations, the report content including the summary content of one or more of the discussion theme with the discussion frequency exceeding the preset frequency, the daily conference overview, the to-do items, and the summary of meeting minutes is generated, so that the user may quickly obtain review and prospect information of a key discussion theme mentioned in the multimedia conferences within the preset time period, and may also quickly obtain an overall situation of the plurality of conferences and make a schedule accordingly. There is no need for the user to manually summarize the content of the plurality of multimedia conferences, or operations of the user for manually summarizing the content of the plurality of multimedia conferences may be reduced, which is beneficial to saving time of the user.

In this embodiment, the message indicating the conference report is displayed in the message feed; the report content of the conference report is displayed in response to the trigger operation to the message, where the report content includes the summary content of at least one dimension, and the summary content of each dimension is obtained by performing content summarization on the conference content of the at least two multimedia conferences in each dimension correspondingly. Therefore, the user may be helped to automatically refine and review the key information based on the recent conference content, so as to quickly review and look ahead to the process of related items. The time cost of the user for going through and sorting out meeting minutes may be reduced, so as to more systematically manage and promote the progress of the related items.

In some embodiments, the report content of the conference report is stored in a cloud document, and the cloud document includes a content segment corresponding to the at least one dimension.

In these embodiments, the report content of the conference report is stored in the form of the cloud document, which may facilitate management of the conference report, and also facilitate editing of the report content by the user, and is beneficial to improving convenience of the user for using the report content.

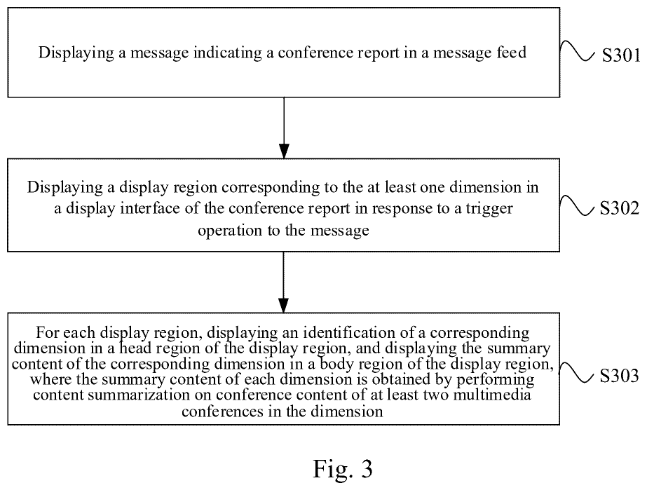

Please refer to FIG. 3. FIG. 3 is a second schematic flowchart of an information processing method according to the present disclosure. As shown in FIG. 3, the method includes the following steps.
S301: displaying a message indicating a conference report in a message feed.
S302: displaying a display region corresponding to the at least one dimension in a display interface of the conference report in response to a trigger operation to the message.

In some examples, the report content of the conference report is stored in a cloud document, and the display interface may be a display interface of the cloud document.

The display region corresponding to the at least one dimension may be displayed in the display interface. It may be understood that a height and/or a width of the display region of each dimension may dynamically change. For example, the height and/or the width of the display region of the dimension may be determined based on a length of content displayed in the dimension and a content layout style of the dimension.
S303: for each display region, displaying an identification of a corresponding dimension in a head region of the display region, and displaying the summary content of the corresponding dimension in a body region of the display region, where the summary content of each dimension is obtained by performing content summarization on conference content of at least two multimedia conferences in the dimension.

Each dimension may correspond to one identification, and the identification of each dimension may include one or more of letters, ideograms, numbers, and punctuation marks. The identification of each dimension may be used to distinguish from other dimensions. Illustratively, for a discussion theme with a discussion frequency exceeding a preset frequency, the identification of this dimension may be, for example, “frequently mentioned items”. For the daily conference overview dimension, the identification of this dimension may be, for example, “daily conference overview”, and so on.

Illustratively, the display region of each dimension may be divided into a head region and a body region. For each dimension, the identification of the dimension may be displayed in the head region corresponding to the dimension, and the summary content of the dimension may be displayed in the body region of the dimension.

In some implementations, the step S303 includes the following sub-steps.

First, a title corresponding to each of at least one discussion theme with a discussion frequency exceeding a preset frequency is displayed in a body region corresponding to a dimension of a discussion theme with a discussion frequency exceeding a preset frequency.

Secondly, for each discussion theme with a discussion frequency exceeding a preset frequency, summary content of following sub-dimensions is displayed in an association region of the title of the discussion theme:
a content summary sub-dimension, a key point summary sub-dimension, and a meeting minutes list sub-dimension.

In these implementations, the discussion theme with the discussion frequency exceeding the preset frequency may be determined from the at least two pieces of multimedia content in advance, and the title of each discussion theme with the discussion frequency exceeding the preset frequency and the summary content of each sub-dimension may be analyzed. When the report content is displayed, the title of each discussion theme with the discussion frequency exceeding the preset frequency may be displayed in the display region of the discussion theme dimension with the discussion frequency exceeding the preset frequency, and the summary content of a plurality of sub-dimensions may be displayed in the association region of the title of each discussion theme with the discussion frequency exceeding the preset frequency.

The association region of the title of the discussion theme with the discussion frequency exceeding the preset frequency, for example, may be located below the title.

In these implementations, the title of the discussion theme is displayed in the display region of the dimension of the discussion theme with the discussion frequency exceeding the preset frequency, and the summary content of the plurality of sub-dimensions is displayed in the association region of the title, so that information access efficiency may be improved. By centrally displaying the discussion theme with the discussion frequency exceeding the preset frequency and detailed information thereof, the user may quickly find required information without searching one by one in a large number of documents or records, and a speed of information retrieval and understanding is improved. In addition, the content summary and the summary of key points are clearly presented, which helps the user quickly grasp core content of the discussion theme and deepen understanding and memory of the discussion theme.

In some implementations, the step S303 includes:
displaying a daily conference summary within a preset time period in the body region of the daily conference overview dimension, where the daily conference summary is generated based on meeting minutes of each day that a user to whom the message feed belongs has permission to view.

In some application scenarios, the multimedia conference that the user has permission to view on one or more dates is a single multimedia conference. In these application scenarios, the daily conference summary on the one or more dates may be meeting minutes of the single multimedia conference.

In some application scenarios, the multimedia conferences that the user has permission to view on one or more dates are more than two multimedia conferences. In these application scenarios, the daily conference summary on the one or more dates may be a conference summary generated based on meeting minutes of the more than two multimedia conferences.

In these implementations, the daily conference summary within the user's permission scope respectively corresponding to a plurality of dates is displayed in the body region of the daily conference overview dimension, so that conference summaries on different dates may be viewed in a centralized manner, which simplifies an information search process without the need to separately access each meeting record or go through a large amount of materials. The related conference content is integrated together, so that the user may quickly understand a theme discussed, a consensus reached, and tasks allocated within a specific time period, which saves time and improves work efficiency. For a user who needs to continuously follow progress of a project or an issue, it is helpful to better understand and review an evolution process of the project, enhancing understanding and review. It is also conducive to information sharing and coordination work between team members, ensuring that everyone is on the same page and reducing communication barriers.

In some implementations, the step S303 further includes:
displaying or hiding a list of the meeting minutes respectively corresponding to at least one day in the body region of the daily conference overview dimension based on an operation of a user, where an amount of the meeting minutes that the user has permission to view in the at least one day is greater than two.

In these implementations, in response to the amount of multimedia meeting minutes that the user has permission to view on a date within a preset time period being greater than two, the more than two meeting minutes are displayed in the display region of the conference summary corresponding to the date. Each of the meeting minutes in the list of meeting minutes may include at least a portion of content extracted from the meeting minutes.

Further, each of the more than two meeting minutes may be further associated with a meeting minute jump link, which is used for the user to directly open details of the meeting minute based on the jump link.

In these implementations, the list of the meeting minutes respectively corresponding to the at least one day is displayed or hidden based on the operation of the user, so that simplicity and readability of the interface are improved. The user may selectively view the meeting minutes of a date of interest as needed without browsing irrelevant information, so that information retrieval efficiency may be improved. By allowing the user to decide which dates of the meeting minutes need to be expanded or hidden, personalized requirements may be better met, and display flexibility and adaptability are improved.

In some implementations, the step S303 further includes:
displaying a to-do item list corresponding to a user to whom the message feed belongs in the body region of the to-do item dimension, where at least one to-do item in the to-do item list is generated based on the meeting minutes of the at least two multimedia conferences.

The to-do item list includes one or more items that need to be processed by the user.

Illustratively, the execution body may traverse the at least two multimedia conferences for to-do items in advance to find one or more to-do items that need to be processed by the user, and then integrate the to-do items of the user in different meeting minutes to obtain the to-do item list.

Further, each to-do item is associated with a hyperlink of a meeting minute in which the to-do item is located, and the hyperlink is used to jump to the meeting minute.

In these implementations, the to-do items that need to be processed by the user are integrated to obtain the to-do item list, so that the user may browse, in the conference report, the to-do items that are determined in different multimedia conferences and need to be processed by the user. This may save time required for the user to view and sort out the to-do items in the meeting minutes of the different multimedia conferences, and may also prevent the user from missing to-do items.

In some implementations, the step S303 further includes:
displaying or hiding a list of meeting minutes in the body region corresponding to the meeting minutes summary dimension based on an operation of a user, where the list of the meeting minutes includes a plurality of meeting minutes that the user has permission to view within a preset time period.

Further, each of the meeting minutes is also associated with a corresponding hyperlink, and the hyperlink is used to jump to a detail page of the meeting minute.

In these implementations, the list of the meeting minutes is displayed or hidden in the body region corresponding to the meeting minutes summary dimension based on the operation of the user, so that a tidy page may be displayed as needed by the user, or the meeting minutes within the preset time period may be displayed. The user does not need to search for the meeting minutes in content corresponding to each of the multimedia conferences, and all the meeting minutes within the preset time period may be viewed through the display region of the meeting minutes dimension, which may provide convenience for the user to search for a plurality of meeting minutes.

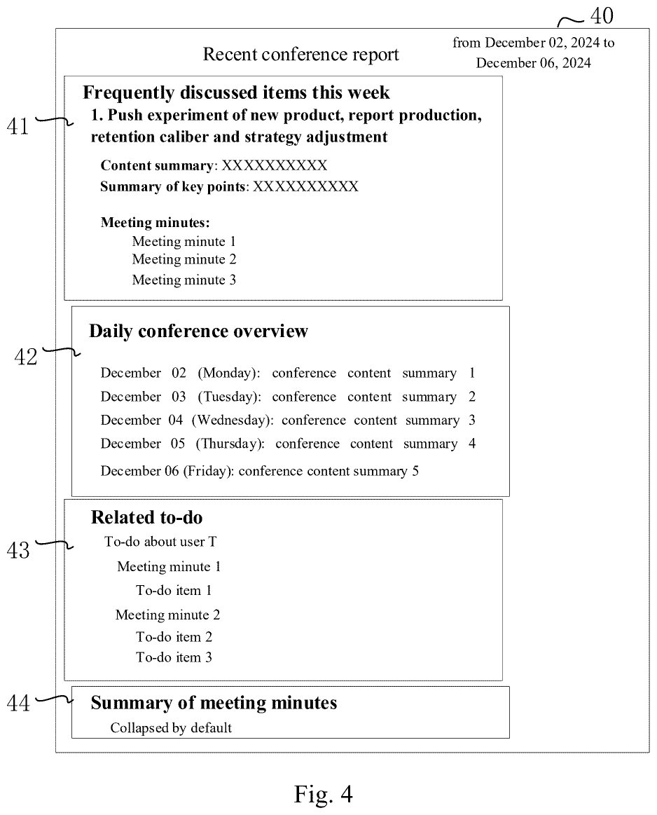

Please refer to FIG. 4. FIG. 4 is a schematic diagram of an application scenario according to another embodiment of the present disclosure. As shown in FIG. 4, report content of a recent conference report (from Dec. 2, 2024 to Dec. 6, 2024) may be displayed in a display interface 40 of a conference report. The display interface 40 includes a display region 41 of a dimension of a discussion theme with a discussion frequency exceeding a preset frequency, a display region 42 of a daily conference overview dimension, a display region 43 of a to-do item dimension, and a display region 44 of a meeting minutes summary dimension. The display regions of each of the dimensions displays corresponding summary content.

As shown in FIG. 4, an identification of “high-frequently discussed items this week” of the dimension is displayed in a head region of the display region 41 of the dimension of the discussion theme with the discussion frequency exceeding the preset frequency. A title of “push experiment of new product, report production, retention caliber and strategy adjustment” of the discussion theme with the discussion frequency exceeding the preset frequency is displayed in a body region. Summary content of several sub-dimensions, namely, a content summary, a summary of key points, and a list of meeting minutes, is displayed below the title.

An identification of “daily conference overview” of the dimension is displayed in a head region of the display region 42 of the daily conference overview dimension. Daily conference summary content is displayed in a body region: a conference content summary C1 on Dec. 2, 2024, a conference content summary C2 on Dec. 3, 2024, a conference content summary C3 on Dec. 4, 2024, a conference content summary C4 on Dec. 5, 2024, and a conference content summary C5 on Dec. 6, 2024.

An identification of “related to-do” of the dimension is displayed in a head region of the display region 43 of the to-do item dimension, and the to-do items of a user “user T” to whom the message feed belongs and identifications of meeting minutes corresponding to the to-do items are displayed in a body region. As shown in FIG. 4, a to-do item 1 in a meeting minute 1, and a to-do item 2 and a to-do item 3 in a meeting minute 2.

An identification of “summary of meeting minutes” of the dimension is displayed in a head region of the display region 44 of the meeting minutes summary dimension, and content in the body region is collapsed by default. A list of a plurality of meeting minutes that the user T has permission to browse during the period from Dec. 2, 2024 to Dec. 6, 2024 may be displayed in the body region based on the operation of the user. The list of the meeting minutes may include respective identifications of the plurality of meeting minutes, and the identification of each of the meeting minutes may be associated with a link to content of the corresponding meeting minute.

In this embodiment, the dimension identification and the corresponding summary content are displayed in the display region of each dimension in the display interface, so that a clear information structure may be provided in the display interface, readability and usability are enhanced, and user experience is improved.

In some optional implementations of this embodiment, the method further includes generating the summary content of the dimension of the discussion theme with the discussion frequency exceeding the preset frequency based on the following steps:
firstly, obtaining meeting minutes of at least two multimedia conferences.

In these implementations, the execution body may obtain the meeting minutes of the at least two multimedia conferences within the preset time period in advance, and the at least two multimedia conferences may be meeting minutes within the permission scope of the user to whom the message feed belongs.

In an application scenario, the execution body may obtain, on a terminal device, the meeting minutes of the at least two multimedia conferences of the user. In some other application scenarios, the execution body may further obtain the meeting minutes of the at least two multimedia conferences based on a user identification of the user at a multimedia conference server.

Secondly, clustering the meeting minutes of the at least two multimedia conferences based on multidimensional vectors of the meeting minutes to obtain a plurality of clustering results, where each of the clustering results includes at least one of the meeting minutes.

In practice, each of the meeting minutes may be vectorized to obtain a multidimensional vector of the corresponding meeting minute. The meeting minutes may be clustered based on the respective multidimensional vectors of the plurality of meeting minutes.

In an example, for each of the meeting minutes, a similarity between the multidimensional vector of a meeting minute and a multidimensional vector of another meeting minute may be calculated, and the another meeting minute with a similarity greater than a similarity threshold may be classified into a same clustering result as the meeting minute.

In an example, various clustering algorithms may be selected to cluster the multidimensional vectors respectively corresponding to different meeting minutes to obtain a plurality of clustering results. The clustering algorithms include a k-means clustering algorithm, a hierarchical clustering algorithm, etc.

Then, sorting the plurality of clustering results in a descending order based on an amount of included meeting minutes.

Afterwards, selecting at least one first clustering result of which a sequence number in a sorting result is less than or equal to a preset threshold.

The preset threshold may be set based on a specific application scenario, and is not limited here. In some examples, the preset threshold may be an integer greater than or equal to 1.

When the preset threshold is 1, it may be considered as generating summary content of a mentioned item with a highest occurrence frequency. The summary content corresponding to the mentioned item with the highest occurrence frequency may be displayed in the display region of the item extracted multiple times, so that the user may have a better understanding of the most important item within the preset time period.

When the preset threshold is greater than 1, it may be considered as that summary content of an item that appears a relatively large number of times in the multimedia conferences needs to be displayed in the conference report, so that the user may have a better understanding of an important item that is discussed more within the preset time period.

Finally, for each first clustering result, generating, based on at least two meeting minutes included in the first clustering result, summary content of a discussion theme with a discussion frequency exceeding a preset frequency corresponding to the first clustering result.

In some application scenarios, the execution body may extract content segments related to the discussion theme with the discussion frequency exceeding the preset frequency from each of the meeting minutes, and reorganize the content segments to obtain the summary content of the discussion theme with the discussion frequency exceeding the preset frequency.

In these implementations, the at least two meeting minutes are clustered based on the multidimensional vectors of the at least two meeting minutes, the plurality of clustering results are sorted based on the number of included meeting minutes, the first clustering result is selected from the sorting result, and the summary content of the discussion theme with the discussion frequency exceeding the preset frequency corresponding to the first clustering result is generated. Therefore, a high-frequency issue may be accurately and automatically identified, and the same or similar discussion content may be aggregated across conferences. The user does not need to search for associated information in each of the meeting minutes, so that efficiency of obtaining the associated information between the conferences is improved, and workload of the user for conference review is reduced.

In some implementations, the for each first clustering result, generating, based on at least two meeting minutes comprised in the first clustering result, summary content of a discussion theme with a discussion frequency exceeding a preset frequency corresponding to the first clustering result comprises: the following sub-steps:
firstly, generating prompt information including the at least two meeting minutes in the first clustering result, where the prompt information further includes generation logics respectively corresponding to a title, a content summary, and a summary of key points of the discussion theme with the discussion frequency exceeding the preset frequency; and
secondly, inputting the prompt information into a machine learning model, and performing, by the machine learning model, content generation for the at least two meeting minutes based on the generation logics to obtain the title, the content summary, and the summary of key points of the discussion theme with the discussion frequency exceeding the preset frequency.

The prompt information may further include a generation rule, and the generation rule includes a title generation rule, a content summary generation rule, and a key point generation rule. Illustratively, the title generation rule may be “extracting a combination of a high-frequency noun phrase and a verb, not exceeding 10 words”. The content summary generation rule may be “summarizing a core contradiction/conclusion in three sentences, keeping neutral”. The key point generation rule may be “listing 3 to 5 key points with decision-making tendencies”.

The title generation logic may include, for example, keyword extraction, combining keywords using a rule engine, and rewriting a keyword combination result by a model.

The content summary generation logic may include, for example, detecting a contradiction point, and copying the detected contradiction point into a content summary template.

The summary of key points generation logic may be, for example, hierarchical extraction logic. Hierarchy levels for hierarchical division include decision items, action items, risk points, etc. Respective regular expressions of each hierarchy level may be used to match key points corresponding to each hierarchy level from the meeting minutes. Then, the key points extracted from different meeting minutes are integrated to obtain the summary of key points corresponding to the discussion theme with the discussion frequency exceeding the preset frequency.

In these implementations, the prompt information is input into the machine learning model, and the summary content of the discussion theme with the discussion frequency exceeding the preset frequency is generated by the machine learning model based on the prompt information, so that relatively accurate summary content of the discussion theme with the discussion frequency exceeding the preset frequency may be obtained, and efficiency of generating the summary content of the discussion theme with the discussion frequency exceeding the preset frequency may also be improved.

In some optional implementations of this embodiment, the method further includes generating the daily conference overview based on the following steps:
in response to an amount of meeting minutes within a permission scope of a user corresponding to one or more dates being greater than two, inputting the more than two meeting minutes into a machine learning model, and generating, by the machine learning model, a daily conference overview respectively corresponding to the one or more dates.

If the amount of the meeting minutes within the permission scope of the user on a date is greater than two, the two meeting minutes may respectively tend to different discussion content, and therefore the two meeting minutes need to be sorted out, so that the user may quickly browse through content of the different meeting minutes in the conference overview on that date.

The at least two meeting minutes corresponding to the date are input into the machine learning model, and the daily conference overview corresponding to the date is generated by the machine learning model, so that efficiency of generating the daily conference overview may be improved.

It may be understood that the prompt information including the at least two meeting minutes within the date may be used, and the prompt information may further include a rule for sorting out the meeting minutes, so that the machine learning model performs content generation for the at least two meeting minutes based on the rule to obtain the daily conference overview corresponding to the date, and the accuracy of the generated daily conference overview may be improved.

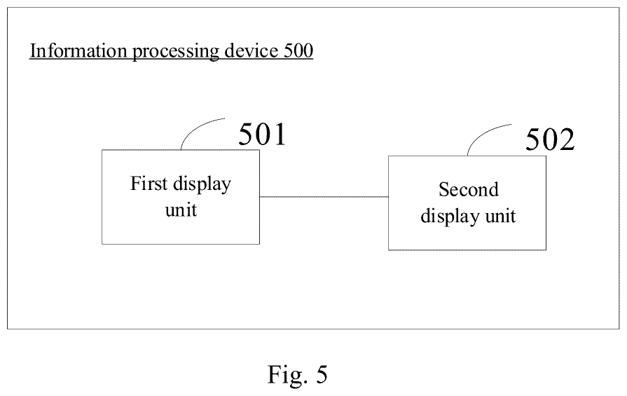

Corresponding to the information processing method of the above embodiments, FIG. 5 is a block diagram of an information processing device according to an embodiment of the present disclosure. For ease of description, only parts related to the embodiments of the present disclosure are shown. Referring to FIG. 5, the information processing device 500 includes a first display unit 501 and a second display unit 502.

The first display unit 501 is configured to display a message indicating a conference report in a message feed; and
the second display unit 502 is configured to display report content of the conference report in response to a trigger operation to the message, where the report content includes at least one summary content corresponding to at least one dimension, respectively, and the summary content of each dimension is obtained by performing content summarization on conference content of at least two multimedia conferences in each dimension correspondingly.

In the information processing device provided in this embodiment of the present disclosure, the first display unit displays the message indicating the conference report in the message feed, and the second display unit displays the report content of the conference report in response to the trigger operation to the message, where the report content includes the at least one summary content corresponding to at least one dimension, respectively, and the summary content of each dimension is obtained by performing content summarization on the conference content of the at least two multimedia conferences in each dimension correspondingly. Therefore, the user may be helped to automatically refine and review key information based on recent meeting minutes, so as to quickly review and look ahead to a process of related items. Time costs of the user for going through and sorting out meeting minutes may be reduced, so as to more systematically manage and promote progress of the related items.

In an embodiment of the present disclosure, the report content includes the at least one summary content corresponding to the at least one dimension of followings:
a dimension of a discussion theme with a discussion frequency exceeding a preset frequency, a daily conference overview dimension, a to-do item dimension, and a meeting minutes summary dimension.

In summary, furthermore, the report content including the summary content of one or more of the discussion themes with the discussion frequency exceeding the preset frequency, the daily conference overview, the to-do items, and the summary of meeting minutes is generated, so that the user may quickly obtain review and prospect information of a key item mentioned in the multimedia conferences within the preset time period, and may also quickly obtain an overall situation of the plurality of conferences and make a schedule accordingly. There is no need for the user to manually summarize the content of the plurality of multimedia conferences, or operations of the user for manually summarizing the content of the plurality of multimedia conferences may be reduced, which is beneficial to saving time of the user.

In an embodiment of the present disclosure, the report content of the conference report is stored in a cloud document, and the cloud document includes a content segment corresponding to the at least one dimension.

In summary, furthermore, the report content of the conference report is stored in the form of the cloud document, which may facilitate management of the conference report, and also facilitate editing of the report content by the user, and is beneficial to improving convenience of the user for using the report content.

In an embodiment of the present disclosure, the second display unit 502 is further configured to:
display a display region corresponding to the at least one dimension in a display interface of the conference report; and
for each display region, display an identification of a corresponding dimension in a head region of the display region, and display the summary content of the corresponding dimension in a body region of the display region.

In summary, furthermore, the dimension identification and the corresponding summary content are displayed in the display region of each dimension in the display interface, so that a clear information structure may be provided in the display interface, readability and usability are enhanced, and user experience is improved.

In an embodiment of the present disclosure, the second display unit 502 is further configured to:
display a title corresponding to each of at least one discussion theme with a discussion frequency exceeding a preset frequency in the body region corresponding to the dimension of the discussion theme with the discussion frequency exceeding the preset frequency; and
for each discussion theme with the discussion frequency exceeding the preset frequency, display summary content of following sub-dimensions in an association region of the title of the discussion theme:
a content summary sub-dimension, a key point summary sub-dimension, and a meeting minutes list sub-dimension.

In summary, furthermore, the title of the discussion theme with the discussion frequency exceeding the preset frequency is displayed in the display region of the dimension of the discussion theme with the discussion frequency exceeding the preset frequency, and the summary content of the plurality of sub-dimensions is displayed in the association region of the title, so that information access efficiency may be improved. By centrally displaying the discussion theme with the discussion frequency exceeding the preset frequency and detailed information thereof, the user may quickly find required information without searching one by one in a large number of documents or records, and a speed of information retrieval and understanding is improved. In addition, the content summary and the summary of key points are clearly presented, which helps the user quickly grasp core content of the discussion theme and deepen understanding and memory of the discussion theme.

In an embodiment of the present disclosure, the second display unit 502 is further configured to:
display a daily conference summary within a preset time period in the body region of the daily conference overview dimension, where the daily conference summary is generated based on meeting minutes of each day that a user to whom the message feed belongs has permission to view.

In summary, furthermore, the daily conference summary within the user's permission scope respectively corresponding to a plurality of dates is displayed in the body region of the daily conference overview, so that the conference summaries on different dates may be viewed in a centralized manner, which simplifies an information search process without the need to separately access each meeting record or go through a large amount of materials. The related conference content is integrated together, so that the user may quickly understand a theme discussed, a consensus reached, and tasks allocated within a specific time period, which saves time and improves work efficiency. For a user who needs to continuously follow progress of a project or an issue, it is helpful to better understand and review an evolution process of the project, enhancing understanding and review. It is also conducive to information sharing and coordination work between team members, ensuring that everyone is on the same page and reducing communication barriers.

In an embodiment of the present disclosure, the second display unit 502 is further configured to:
display or hide a list of meeting minutes respectively corresponding to at least one day in the body region based on an operation of the user, where an amount of the meeting minutes that the user has permission to view in the at least one day is greater than two.

In summary, furthermore, the list of the meeting minutes respectively corresponding to the at least one day is displayed or hidden based on the operation of the user, so that simplicity and readability of the interface are improved. The user may selectively view meeting minutes of a date of interest as needed without browsing irrelevant information, so that information retrieval efficiency may be improved. By allowing the user to decide which dates of meeting minutes need to be expanded or hidden, personalized requirements may be better met, and display flexibility and adaptability are improved.

In an embodiment of the present disclosure, the second display unit 502 is further configured to:
display a to-do item list corresponding to a user to whom the message feed belongs in the body region of the to-do item dimension, where at least one to-do item in the to-do item list is generated based on meeting minutes of the at least two multimedia conferences.

In summary, furthermore, the to-do items that need to be processed by the user are integrated to obtain the to-do item list, so that the user may browse, in the conference report, the to-do items that are determined in different multimedia conferences and need to be processed by the user, which may save time required for the user to view and sort out the to-do items in the meeting minutes of the different multimedia conferences, and may also prevent the user from missing to-do items.

In an embodiment of the present disclosure, the second display unit 502 is further configured to:
display or hide a list of meeting minutes in a body region corresponding to the meeting minutes summary dimension based on an operation of a user, where the list of the meeting minutes includes a plurality of meeting minutes that the user has permission to view within a preset time period.

In summary, furthermore, in these implementations, the list of meeting minutes is displayed or hidden in the body region corresponding to the meeting minutes summary dimension based on the operation of the user, so that a tidy page may be displayed as needed by the user, or the meeting minutes within the preset time period may be displayed. The user does not need to search for the meeting minutes in content corresponding to each multimedia conference, and all meeting minutes within the preset time period may be viewed through the display region of the meeting minutes summary dimension, which may provide convenience for the user to search for a plurality of meeting minutes.

In an embodiment of the present disclosure, the device further includes a first content generation unit (not shown in the figure), and the first content generation unit is configured to:
obtain meeting minutes of at least two multimedia conferences;
cluster the meeting minutes of the at least two multimedia conferences based on multidimensional vectors of the meeting minutes to obtain a plurality of clustering results, where each of the clustering results includes at least one of the meeting minutes;
sort the plurality of clustering results in a descending order based on an amount of included meeting minutes;
select at least one first clustering result of which a sequence number in a sorting result is less than a preset threshold; and
for each first clustering result, generate, based on at least two meeting minutes included in the first clustering result, summary content of a discussion theme with a discussion frequency exceeding a preset frequency corresponding to the first clustering result.

In summary, furthermore, the at least two meeting minutes are clustered based on the multidimensional vectors of the at least two meeting minutes, the plurality of clustering results are sorted based on the number of included meeting minutes, the first clustering result is selected from the sorting result, and the summary content of the discussion theme with the discussion frequency exceeding the preset frequency corresponding to the first clustering result is generated. Therefore, a high-frequency issue may be accurately and automatically identified, and the same or similar discussion content may be aggregated across conferences. The user does not need to search for associated information in each meeting minute, so that efficiency of obtaining the associated information between the conferences is improved, and workload of the user for conference review is reduced.

In an embodiment of the present disclosure, the first content generation unit is further configured to: for each first clustering result, generate prompt information including the at least two meeting minutes in the first clustering result, where the prompt information further includes generation logics respectively corresponding to a title, a content summary, and a summary of key points of the discussion theme with the discussion frequency exceeding the preset frequency; and
input the prompt information into a machine learning model, and perform, by the machine learning model, content generation for the at least two meeting minutes based on the generation logics to obtain the title, the content summary, and the summary of key points of the discussion theme with the discussion frequency exceeding the preset frequency.

In summary, furthermore, the prompt information is input into the machine learning model, and the summary content of the discussion theme with the discussion frequency exceeding the preset frequency is generated by the machine learning model based on the prompt information, so that relatively accurate summary content of the discussion theme with the discussion frequency exceeding the preset frequency may be obtained, and efficiency of generating the summary content of the discussion theme with the discussion frequency exceeding the preset frequency may also be improved.

In an embodiment of the present disclosure, the device further includes a second content generation unit (not shown in the figure), and the second content generation unit is configured to:
in response to an amount of meeting minutes within the permission scope of the user corresponding to one or more dates being greater than two, input the more than two meeting minutes into a machine learning model, and generate, by the machine learning model, a daily conference overview respectively corresponding to the one or more dates.

In summary, furthermore, the at least two meeting minutes corresponding to the date are input into the machine learning model, and the daily conference overview corresponding to the date is generated by the machine learning model, so that efficiency of generating the daily conference overview may be improved.

In order to implement the above embodiments, an embodiment of the present disclosure further provides an electronic device.

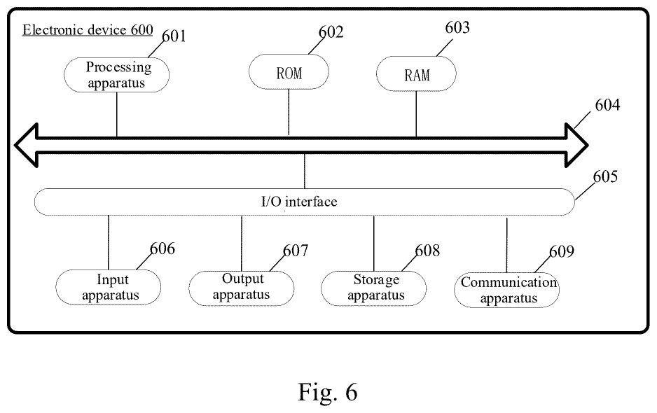

Referring to FIG. 6, FIG. 6 shows a schematic structural diagram of an electronic device 600 suitable for implementing the embodiments of the present disclosure, and the electronic device 600 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), a vehicle-mounted terminal (for example, a vehicle navigation terminal), and the like, and a fixed terminal such as a digital TV, a desktop computer, and the like. The electronic device shown in FIG. 6 is only an example, and should not impose any limitation on the function and scope of use of the embodiments of the present disclosure.

As shown in FIG. 6, the electronic device 600 may include a processing apparatus 601 (such as a central processing unit, a graphics processor, etc.), which may perform various appropriate actions and processing based on a program stored in a read-only memory (abbreviated as ROM) 602 or a program loaded from a storage apparatus 608 into a random access memory (abbreviated as RAM) 603. In the RAM 603, various programs and data required for operations of the electronic device 600 are also stored. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (Liquid Crystal Display, LCD for short), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a computer-readable storage medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the functions defined in the method of the embodiments of the present disclosure are executed.

It should be noted that the computer-readable storage medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination of the above. The computer-readable signal medium may also be any readable storage medium other than the computer-readable storage medium, and the computer-readable signal medium may send, propagate, or transmit a program for use by or in combination with an instruction execution system, apparatus, or device. The program code contained on the computer-readable storage medium may be transmitted by any suitable medium, including, but not limited to: a wire, an optical cable, an RF (radio frequency), etc., or any suitable combination of the above.

The computer-readable storage medium may be included in the electronic device, or may exist alone without being assembled into the electronic device.

The computer-readable storage medium carries one or more programs (computer-executable instructions), and when the one or more programs are executed by the electronic device, the electronic device is caused to perform the method shown in the above embodiments.

The computer program code for performing the operations of the present disclosure may be written in one or more programming languages or a combination thereof, where the programming languages include an object-oriented programming language such as Java, Smalltalk, C++, and also include conventional procedural programming languages such as “C” language or similar programming languages. The program code may be executed entirely on a computer of a user, partly on the computer of the user, as a stand-alone software package, partly on the computer of the user and partly on a remote computer, or entirely on the remote computer or a server. In the case of involving the remote computer, the remote computer may be connected to the computer of the user through any kind of network, including a local area network (Local Area Network, LAN for short) or a wide area network (Wide Area Network, WAN for short), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of a unit does not constitute a limitation on the unit itself under certain circumstances, and for example, the first obtaining unit may also be described as “a unit for obtaining at least two internet protocol addresses”.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the electronic device, the computer-readable storage medium, and the computer program product provided in the embodiments of the present disclosure, the message indicating the conference report is displayed in the message feed, and the report content of the conference report is displayed in response to the trigger operation to the message, where the report content includes at least one summary content corresponding to at least one dimension, respectively, and the summary content of each dimension is obtained by performing content summarization on the conference content of at least two multimedia conferences in each dimension correspondingly. Therefore, the user may be helped to automatically refine and review key information based on recent intelligent meeting minutes, so as to quickly review and look ahead to the process of related items. Time costs of the user for going through and sorting out meeting minutes may be reduced, so as to more systematically manage and promote the progress of the related items.

The above description is merely preferred embodiments of the present disclosure and an explanation of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalent features. For example, a technical solution formed by a replacement of the above features with technical features with similar functions disclosed in the present disclosure (but not limited thereto).

In addition, although the operations are depicted in a particular order, this should not be understood as requiring the operations to be performed in the particular order shown or in a sequential order. Under certain circumstances, multitasking and parallel processing may be advantageous. Likewise, although the above discussion includes several specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely example forms of implementing the claims.

1. An information processing method, comprising:
displaying a message indicating a conference report in a message feed; and
displaying report content of the conference report in response to a trigger operation to the message, wherein the report content comprises at least one summary content corresponding to at least one dimension, respectively, and the summary content of each dimension is obtained by performing content summarization on conference content of at least two multimedia conferences in each dimension correspondingly.

2. The method of claim 1, wherein the report content comprises the at least one summary content corresponding to the at least one dimension of followings:
a dimension of a discussion theme with a discussion frequency exceeding a preset frequency, a daily conference overview dimension, a to-do item dimension, and a meeting minutes summary dimension.

3. The method of claim 1, wherein the report content of the conference report is stored in a cloud document, and the cloud document comprises a content segment corresponding to the at least one dimension.

4. The method of claim 2, wherein the displaying report content of the conference report comprises:
displaying a display region corresponding to the at least one dimension in a display interface of the conference report; and
for each display region, displaying an identification of a corresponding dimension in a head region of the display region, and displaying the summary content of the corresponding dimension in a body region of the display region.

5. The method of claim 4, wherein the for each display region, displaying an identification of a corresponding dimension in a head region of the display region, and displaying the summary content of the corresponding dimension in a body region of the display region comprises:
displaying a title corresponding to each of at least one discussion theme with a discussion frequency exceeding a preset frequency in a body region corresponding to the dimension of the discussion theme with the discussion frequency exceeding the preset frequency; and
for each discussion theme with the discussion frequency exceeding the preset frequency, displaying summary content of following sub-dimensions in an association region of a title of a corresponding discussion theme:
a content summary sub-dimension, a key point summary sub-dimension, and a meeting minutes list sub-dimension.

6. The method of claim 4, wherein the for each display region, displaying an identification of a corresponding dimension in a head region of the display region, and displaying the summary content of the corresponding dimension in a body region of the display region comprises:
displaying a daily conference summary within a preset time period in a body region of the daily conference overview dimension, wherein the daily conference summary is generated based on meeting minutes of each day that a user to whom the message feed belongs has permission to view.

7. The method of claim 4, wherein the for each display region, displaying an identification of a corresponding dimension in a head region of the display region, and displaying the summary content of the corresponding dimension in a body region of the display region further comprises:
displaying or hiding a list of meeting minutes respectively corresponding to at least one day in the body region based on an operation of a user, wherein an amount of the meeting minutes that the user has permission to view in the at least one day is greater than two.

8. The method of claim 4, wherein the for each display region, displaying an identification of a corresponding dimension in a head region of the display region, and displaying the summary content of the corresponding dimension in a body region of the display region comprises:
displaying a to-do item list corresponding to a user to whom the message feed belongs in the body region of the to-do item dimension, wherein at least one to-do item in the to-do item list is generated based on meeting minutes of the at least two multimedia conferences.

9. The method of claim 4, wherein the for each display region, displaying an identification of a corresponding dimension in a head region of the display region, and displaying the summary content of the corresponding dimension in a body region of the display region comprises:
displaying or hiding a list of meeting minutes in a body region corresponding to the meeting minutes summary dimension based on an operation of a user, wherein the list of the meeting minutes comprises a plurality of meeting minutes that the user has permission to view within a preset time period.

10. The method of claim 2, wherein the method further comprises generating summary content of the dimension of the discussion theme with the discussion frequency exceeding the preset frequency based on following steps:
obtaining meeting minutes of the at least two multimedia conferences;
clustering the meeting minutes of the at least two multimedia conferences based on multidimensional vectors of the meeting minutes to obtain a plurality of clustering results, wherein each of the clustering results comprises at least one of the meeting minutes;
sorting the plurality of clustering results in a descending order based on an amount of comprised meeting minutes;
selecting at least one first clustering result of which a sequence number in a sorting result is less than a preset threshold; and
for each first clustering result, generating, based on at least two meeting minutes comprised in the first clustering result, summary content of a discussion theme with a discussion frequency exceeding a preset frequency corresponding to the first clustering result.

11. The method of claim 10, wherein the for each first clustering result, generating, based on at least two meeting minutes comprised in the first clustering result, summary content of a discussion theme with a discussion frequency exceeding a preset frequency corresponding to the first clustering result comprises:
for each first clustering result, generating prompt information comprising the at least two meeting minutes in the first clustering result, wherein the prompt information further comprises generation logics respectively corresponding to a title, a content summary, and a summary of key points of the discussion theme with the discussion frequency exceeding the preset frequency; and
inputting the prompt information into a machine learning model, and performing, by the machine learning model, content generation for the at least two meeting minutes based on the generation logics to obtain the title, the content summary, and the summary of key points of the discussion theme with the discussion frequency exceeding the preset frequency.

12. The method of claim 2, wherein the method further comprises generating a daily conference overview based on following steps:
in response to an amount of meeting minutes within a permission scope of a user corresponding to one or more dates being greater than two, inputting the meeting minutes into a machine learning model, and generating, by the machine learning model, a daily conference overview respectively corresponding to the one or more dates.

13. An electronic device, comprising: a processor and a memory,
wherein the memory stores computer-executable instruction; and
the processor executes the computer-executable instruction stored in the memory, causing the processor to perform an information processing method, and the information processing method comprises:
displaying a message indicating a conference report in a message feed; and
displaying report content of the conference report in response to a trigger operation to the message, wherein the report content comprises at least one summary content corresponding to at least one dimension, respectively, and the summary content of each dimension is obtained by performing content summarization on conference content of at least two multimedia conferences in each dimension correspondingly.

14. The electronic device of claim 13, wherein the report content comprises the at least one summary content corresponding to the at least one dimension of followings:
a dimension of a discussion theme with a discussion frequency exceeding a preset frequency, a daily conference overview dimension, a to-do item dimension, and a meeting minutes summary dimension.

15. The electronic device of claim 13, wherein the report content of the conference report is stored in a cloud document, and the cloud document comprises a content segment corresponding to the at least one dimension.

16. The electronic device of claim 14, wherein the displaying report content of the conference report comprises:
displaying a display region corresponding to the at least one dimension in a display interface of the conference report; and
for each display region, displaying an identification of a corresponding dimension in a head region of the display region, and displaying the summary content of the corresponding dimension in a body region of the display region.

17. The electronic device of claim 16, wherein the for each display region, displaying an identification of a corresponding dimension in a head region of the display region, and displaying the summary content of the corresponding dimension in a body region of the display region comprises:
displaying a title corresponding to each of at least one discussion theme with a discussion frequency exceeding a preset frequency in a body region corresponding to the dimension of the discussion theme with the discussion frequency exceeding the preset frequency; and
for each discussion theme with the discussion frequency exceeding the preset frequency, displaying summary content of following sub-dimensions in an association region of a title of a corresponding discussion theme:
a content summary sub-dimension, a key point summary sub-dimension, and a meeting minutes list sub-dimension.

18. The electronic device of claim 16, wherein the for each display region, displaying an identification of a corresponding dimension in a head region of the display region, and displaying the summary content of the corresponding dimension in a body region of the display region comprises:
displaying a daily conference summary within a preset time period in a body region of the daily conference overview dimension, wherein the daily conference summary is generated based on meeting minutes of each day that a user to whom the message feed belongs has permission to view.

19. The electronic device of claim 18, wherein the for each display region, displaying an identification of a corresponding dimension in a head region of the display region, and displaying the summary content of the corresponding dimension in a body region of the display region further comprises:
displaying or hiding a list of meeting minutes respectively corresponding to at least one day in the body region based on an operation of the user, wherein an amount of the meeting minutes that the user has permission to view in the at least one day is greater than two.

20. A non-transitory computer-readable storage medium, wherein the non-transitory computer-readable storage medium stores computer-executable instruction, and when a processor executes the computer-executable instruction, an information processing method is implemented, and the information processing method comprises:
displaying a message indicating a conference report in a message feed; and
displaying report content of the conference report in response to a trigger operation to the message, wherein the report content comprises at least one summary content corresponding to at least one dimension, respectively, and the summary content of each dimension is obtained by performing content summarization on conference content of at least two multimedia conferences in each dimension correspondingly.
